(19) United States
(12) Patent Application Publication
(10) Pub. No.: US 2011/0004926 A1
(43) Pub. Date: Jan. 6, 2011

(54) Automatically Handling Proxy Server and Web Server Authentication

(75) Inventors: James P. O'Donnell, III, Austin, TX (US); Rama S. Vykunta, Round Rock, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Coporation, Armonk, NY (US)

(21) Appl. No.: 12/496,116

(22) Filed: Jul. 1, 2009

(51) Int. Cl. H04L 9/32; G06F 21/00

(52) U.S. Cl. 726/7; 726/12; 726/3

(57) ABSTRACT

A mechanism is provided for automatically handling server authentication. Responsive to receiving a response to a synthetic transaction from a server, a determination is made as to whether the response contains an authentication challenge. If the response contains the authentication challenge, the response is parsed to identify one or more attributes associated with the authentication challenge. A determination is made as to whether one or more attributes associated with each realm in a set of realms stored in a realm list matches the one or more attributes associated with the authentication challenge. If there is a match, an authentication response to the authentication challenge is generated for the matched realm. The authentication response is then sent automatically to the server in order to authenticate the synthetic transaction.

### BACKGROUND

The present application relates generally to an improved data processing apparatus and method and more specifically to an apparatus and method for auto-handling proxy server and web server authentication in synthetic transaction monitoring and application management software and systems.

Synthetic or robotic transactions are an integral part of any modern day composite application management and monitoring software. Synthetic transactions, which may also be referred to as robotic transactions, refer to transactions that serve to exercise the system programming and infrastructure to isolate performance and availability issues in composite applications and systems. Synthetic transactions are extremely useful for proactive monitoring of enterprise and customer facing applications published to the Internet/Intranet on a variety of web servers, application servers, directory servers, or the like. Synthetic transactions may generate rich sets of data on how the customers or end users are experiencing the published applications, how well (or badly) the applications are responding relative to the client and server, or how the availability and performance service level agreements (SLAs) are maintained over a period of time and across different points of the network.

With the onslaught of security incidents in the recent past, many companies are employing a number of techniques to protect and access control of the enterprise and customer facing applications that are available on the Internet/Intranet. The techniques may include setting up a web server realm on a web server or a proxy load-balancer authenticating a user and redirecting the user to the appropriate available web server. With the increased complexity of the security mechanisms for hosted applications, the task of generating and maintaining synthetic transactions has become very complex. Further, automatically handling the authentication to access these enterprise application environments through proxies and web servers, from within the synthetic transaction generating components, is a challenge, as the agents may collect performance, availability, and end-user experience data from various points of the network within and outside of the corporate Intranet. That is, recorded scripts, procedures, functions need to change every time something changes in the environment, such as changes to the web application environment, changes to web server software, changes to the authentication mechanism, addition of new security policies, access control lists, new routes added to the network, firewall changes, or the like. Furthermore, a real user recording the script may be different from synthetic transactions performing the monitoring of the web application environment and simulating different users from the same monitoring agent and points in the network may be almost impossible because the monitoring agent will have to create a different script for each user and/or for different sets of credentials and for each point in the network.

### SUMMARY

In one aspect of the invention, a method, in a data processing system, is provided for automatically handling server authentication. In this aspect, a data processing system determines whether a response from a server to a synthetic transaction in a set of synthetic transactions contains an authentication challenge. The data processing system parses the response to identify one or more attributes associated with the authentication challenge in response to the response containing the authentication challenge. The data processing system determines whether one or more attributes associated with each realm in a set of realms stored in a realm list matches the one or more attributes associated with the authentication challenge. The data processing system generates an authentication response to the authentication challenge for the matched realm in response to a match of the one or more attributes associated with a realm in the set of realms to the one or more attributes of the authentication challenge. The data processing system sends the authentication response automatically to the server in order to authenticate the synthetic transaction.

In another aspect of the invention, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another aspect of the invention, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 shows a block diagram of an example data processing system in which aspects of the illustrative embodiments may be implemented;

FIG. 3 depicts one example of a management and monitoring system for auto-handling proxy server and web server authentication in accordance with an illustrative embodiment;

FIGS. 4A and 4B depict a flow chart for the operation performed by an administrator and recording endpoint of a management and monitoring system in accordance with an illustrative embodiment; and

FIGS. 5A and 5B depict a flow chart for the operation performed by a remote monitoring endpoint of a management and monitoring system in accordance with an illustrative embodiment.

### DETAILED DESCRIPTION

The illustrative embodiments provide a mechanism for automatically handling proxy server and web server authentication. The mechanism handles authentication done through or using web server realms and proxy server realms in proactive monitoring and management of web application environments distributed inside and outside of the corporate Intranet.

As will be appreciated by one skilled in the art, the present invention may be embodied as a system, method, or computer program product. Accordingly, the present invention may take the form of an entirely hardware embodiment, an entirely software embodiment on a computer recordable medium (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an Intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In addition, the program code may be embodied on a computer readable storage medium on the server or the remote computer and downloaded over a network to a computer readable storage medium of the remote computer or the users' computer for storage and/or execution. Moreover, any of the computing systems or data processing systems may store the program code in a computer readable storage medium after having downloaded the program code over a network from a remote computing system or data processing system.

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

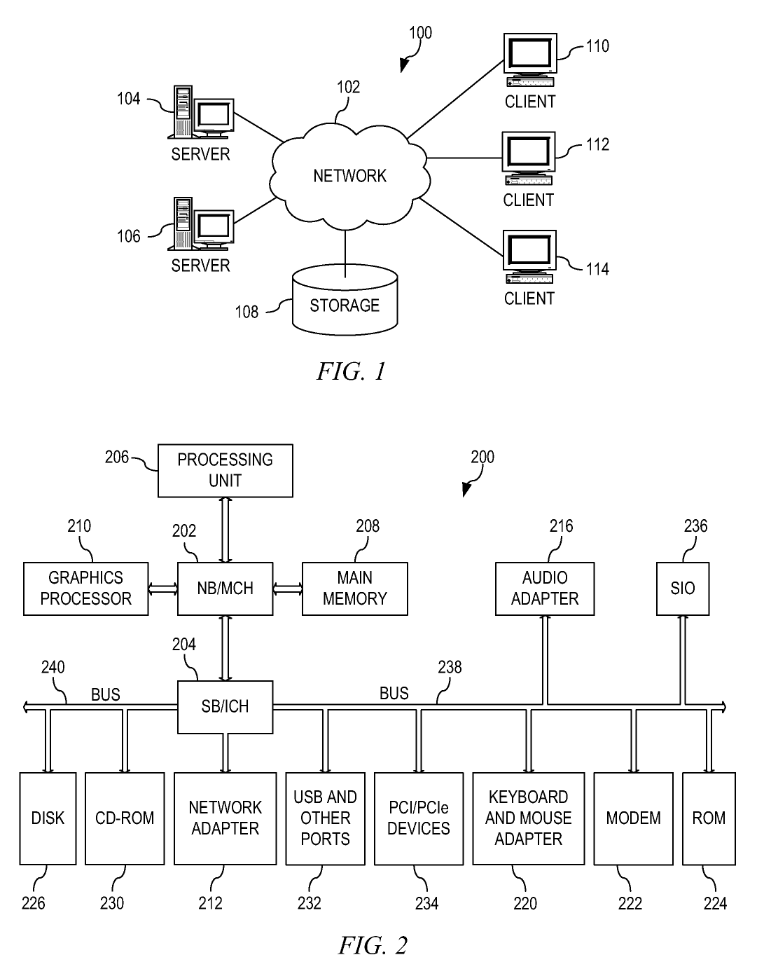

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation of an automatically handling proxy and web server authentication mechanism, this is only an example and is not intended to state or imply any limitation with regard to the features of the present invention. To the contrary, the illustrative embodiments are intended to include distributed data processing environments and embodiments in which authentication may be automatically handled in proxy and web servers.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106, which may be web server, a proxy server, or any server with a security realm, are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an Intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

In a web based application environment, “realms” may protect resources like files, directories, images, application resources, or the like. Realms may assign certain systems to trusted groups of systems using a web server or may protect and control access using a proxy server. When accessed using a application client, such a Web Browser using Hypertext Transfer Protocol (HTTP) transport protocol, Web servers return a HTTP response code of “401” if these resources are not accessed using proper authentication information and similarly proxy servers returns a HTTP response code of “407” if the resources are not accessed using proper authentication information. Along with a “401” or “407” response code, the web server or the proxy server responds with certain other information like the name associated with the protection area, the host name, and/or IP Address of the machine that is trying to protect these resources, or other optional entities. This information may be called the realm or the authentication mechanism. This information may also be called a web server realm if web server is protecting the resource or proxy server realm if a proxy server is involved in the protection. Realms may use a variety of authentication mechanisms including but not limited to NT LAN Manager (NTLM), Kerberos™, Integrated Windows Authentication (IWA), Simple and Protected GSSAPI Negotiation Mechanism (SPNEGO), or the like.

Synthetic transactions drive proactive monitoring and management of web application environments to use the web application environment over a regular period by performing some transactions on the web application environment and repeating these sequences of transactions at periodic intervals from across various points of the network inside and outside of the Intranet with the help of a script, function, or procedure are described below. Typically, the synthetic transactions are provided with a list of transactions to perform (typically in the form of a pre-recorded script generated in a variety of programming/scripting languages like visual basic (VB), C, C++, C#, Java™, extensible markup language (XML), Python®, Perl™, etc.) on the web application environment. Many times the transaction will be a simulated business transaction, such as searching for a book, adding the book to the shopping cart, and finally checking the book out using an online book catalog sales application. Other simulated business transactions may comprise logging into a checking account and transferring money to a connected savings account using an online banking application.

Synthetic transaction components have two high level pieces: the recording component and the playback component. The recording component initially records a set of transactions a real user performs in a web application environment as a script, procedure, or function in a programming language. Typically during the creation of this script, procedure, or function from real user transactions, if the recording phase encounters any web server realm or proxy server realm during the execution of a request by a real user, the recording component captures the web server or proxy server realm and adds the captured realm information to the script, procedure, or function as an attribute to the transaction the user performed. The playback component uses the script, procedure, or function produced by the recording component to drive synthetic transactions against the web application environment.

The management and monitoring system, which may also be referred to as a data processing system, of the illustrative embodiments provides for automatically handling proxy server and/or web server authentication. The management and monitoring system handles web server realms and proxy server realms in proactive monitoring and management of web application environments distributed inside and outside of the corporate Intranet.

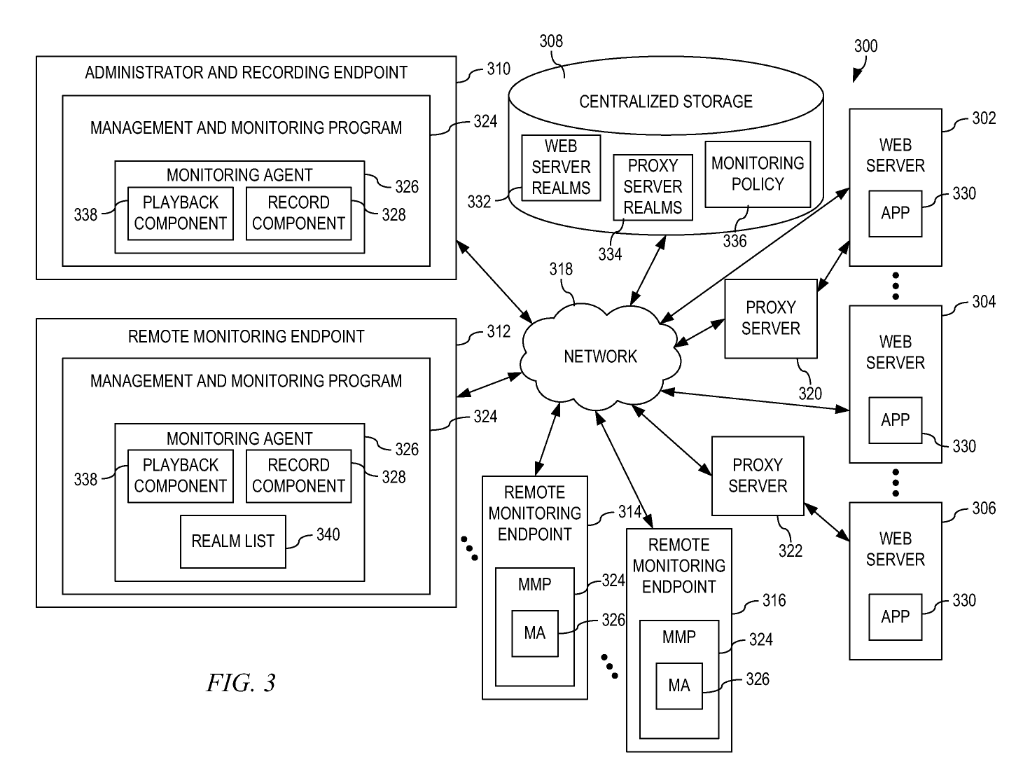

FIG. 3 depicts one example of a management and monitoring system for automatically handling proxy server and web server authentication in accordance with an illustrative embodiment. Management and monitoring system 300 may comprise web servers 302, 304, and 306, centralized storage 308, administrator and recording endpoint 310, and remote monitoring endpoints 312, 314, and 316 all coupled to network 318. Web servers 302, 304 or 306 may be directly coupled to network 318 or coupled to network 318 through a proxy server. For illustration purposes, web server 302 couples directly to network 318 as well as coupling to network 318 through proxy server 320. Further, web server 304 couples directly to network 318 and web server 306 couples to network 318 through proxy server 322. Upon an administrator initializing management and monitoring program 324 on administrator and recording endpoint 310 for recording the transactions of a real user, which in this simple case is same as the administrator, is going to perform on the web application 330, monitoring agent 326 within management and monitoring program 324 uses recording component 328 to record a script containing a list of transactions the real user performed on application 330 resident and available through web servers 302, 304 or 306. In this example, application 330 is an application that is to be proactively accessed and monitored for availability, response time and end-user experience from various points throughout the network, such as from remote endpoints 312, 314, 316, or the like.

As recording component 328 records a script containing a list of transactions the real user is performing on application 330, the real user may receive a server specific authentication challenge from web server 302, 304, or 306 and/or proxy server 320 or 322 depending on the security realm enforced by the web server or proxy server for application 330. Recording component 328 recognizes these specific authentication challenges and responses a real user is receiving during interactions with application 330 and records information from the authentication challenge associated with each of web server 302, 304, or 306 and/or proxy server 320 or 322, such as a type attribute, subnet, security realm name, or the like. The type attribute identifies the authentication scheme being used on the web server or proxy server. The subnet attribute identifies the web server or proxy server where the information is retrieved. The realm name attribute is used to identify the realm in an authentication challenge. Upon receiving the authentication challenge, recording component 328 may also record the username and password that is provided by the administrator as part of this authentication challenge during his interaction with application 330 on web servers 302, 304, and 306. Recording component 328 records this information for use in the synthetic transaction access to determine performance, availability, and end-user experience of application 330 on web servers 302, 304, and 306, which will be described in detail below. Recording component 328 stores the recorded web server information or proxy server information along with the associated recorded username and password as entries in web server realms 332 or proxy server realms 334 in centralized storage 308. Web server realms 332 and proxy server realms 334 may be data structures on centralized storage 308, which may be a database server, flat file, extensible markup language (XML) repository, configuration management (CM) system, management server, or the like. The administrator may also store monitoring policy 336 in centralized storage 308 for use in the synthetic transaction access to determine performance, availability, and end-user experience that identifies one or more of a transaction, a situation, a task, a job, or the like, in which the monitoring should be performed as well as one or more of a schedule, pre-recorded script, function, procedure to use, or the like to use during synthetic transaction access.

After web server realms 332, proxy server realms 334, and monitoring policy 336 are populated on centralized storage 308, the administrator may initialize management and monitoring program 324 on remote monitoring endpoints 312, 314, and 316 and associate a monitoring policy to each of remote monitoring endpoints 312, 314, and 316. Remote monitoring endpoints 312, 314, and 316 may be located at geographically diverse locations in order to accurately simulate a user's application access experience by collecting response time, availability, and end-user application experience information. Upon initialization, each management and monitoring program 324 on remote monitoring endpoints 312, 314, and 316 downloads monitoring policy 336 from centralized storage 308 and executes the monitoring policy using monitoring agent 326. Each monitoring agent 326 on remote monitoring endpoints 312, 314, and 316 then downloads a copy or replica of the information in web server realms 332 and proxy server realms 334 from centralized storage 308 as local realm list 340.

Each monitoring agent 326 on remote monitoring endpoints 312, 314, and 316 then activates playback component 338, generates a set of synthetic transactions using the script, function, or procedure associated with the monitoring policy, and sends the set of synthetic transactions to one or more of web servers 302, 304, or 306 and/or one or more of proxy servers 320 or 322 depending on the path the request takes to the intended web server. That is, each monitoring agent 326 starts driving the transaction, situation, task, job, or the like for the synthetic transaction using the schedule, recorded scripts, function, procedure, or the like defined in monitoring policy 336. Again, the monitoring policy 336 identifies the transaction, the situation, the task, the job, or the like, the administrator identified as needing to be performed in order to accurately monitor and measure a user's application experience as well as availability and response time of application 330. In response to the request, each playback component 338 in remote monitoring endpoints 312, 314, and 316, may receive an authentication challenge from web servers 302, 304, or 306 or proxy servers 320 or 322.

In response to receiving the authentication challenge, playback component 338 parses attributes associated with the authentication challenge, such as a type, subnet, realm name, or the like. Playback component 338 then determines if a matching web server realm or proxy server realm exists in realm list 340 using the attributes of the authentication challenge and the attributes associated with the web server realms and proxy server realms replicated from web server realms 332 and proxy server realms 334. Playback component 338 may determine a match when a number of attributes in the authentication challenge matches a number of attributes associated with the web server realms and proxy server realms above a predetermined percentage such as 3 out of 4 matching attributes which translates to 75%, 3 out of 5 matching attributes which translates to 60%, an exact match requiring all components match which translates to 100%, or the like. If playback component 338 identifies a web server realm or proxy server realm that matches the attributes parsed from the authentication challenge, playback component 338 generates an authentication response to the authentication challenge that is formatted based on the authentication mechanism associated with the web server or proxy server that initiated the authentication challenge and identified by playback component 338. The authentication response includes any information required by the identified authentication mechanism and the username and password associated with the identified web server realm or proxy server realm in a format required by that type of authentication mechanism or scheme.

Playback component 338 then resends the request with authentication response included in the request to the web server or proxy server that sent the authentication challenge. If the web server or proxy server that sent the authentication challenge accepts the authentication response, then monitoring agent 326 proceeds to the next authentication challenge received (if any) from web servers 302, 304, or 306 or proxy servers 320 or 322 for the same request or to the next transaction in the script, function, or procedure. If the web server or proxy server that sent the authentication challenge fails to accept the authentication response or if playback component 338 fails to identify a web server realm or proxy server realm that matches the attributes parsed from the authentication challenge, playback component 338 determines if another web server realm or proxy server realm may be identified that is the closest match to the attributes parsed from the authentication challenge.

That is, playback component 338 uses a web server realm or proxy server realm, if any, that is identified in the schedule, recorded script, function, procedure, or the like, for the transaction, situation, task, job, or the like, being performed by the initial request. If playback component 338 identifies a web server realm or proxy server realm associated with the transaction, situation, task, job, or the like, playback component 338 generates an authentication response to the authentication challenge that is formatted based on the identified web server realm or proxy server realm associated with the initial request. The authentication response includes any information required by the authentication mechanism of the identified web server realm or proxy server realm and the username and password associated with the identified web server realm or proxy server realm.

Playback component 338 then resends the request with authentication response included in the request to the web server or proxy server that sent the authentication challenge. If the web server or proxy server that sent the authentication challenge accepts the authentication response, then monitoring agent 326 proceeds to the next authentication challenge received from web servers 302, 304, or 306 or proxy servers 320 or 322 for the same request (if any) or to the next transaction in the script, procedure, or function. If the web server or proxy server that sent the authentication challenge again fails to accept the authentication response or if playback component 338 fails to identify a web server realm or a proxy server realm associated with the transaction, situation, task, job, or the like, monitoring agent 326 generates a system alert to administrator and recording endpoint 310 and aborts the request.

Upon receiving the system alert from monitoring agent 326 on one of remote monitoring endpoints 312, 314, and 316, management and monitoring program 324 on administrator and recording endpoint 310 prompts the system administrator as to whether the administrator would like to save the attributes associated with the authentication challenge as a new web server realm or a new proxy server realm in web server realms 332 or proxy server realms 334 stored in centralized repository 308. If the administrator indicates that the information is to be saved as a new web server realm or a new proxy server realm, then management and monitoring program 324 stores the recorded web server information or proxy server information along with the associated username and password as entries in web server realms 332 or proxy server realms 334 in centralized storage 308.

When all of the requests of authentication are successful and when monitoring agent 326 on remote monitoring endpoints 312, 314 and 316 completes all transactions defined in the script, procedure, or function associated with monitoring policy 336, then monitoring agent 326 reports back the availability and response time results of each of the defined transactions and their perceived user experience of application 330 accessed by the defined transactions on web servers 302, 304, and 306.

Thus, a mechanism is provided that automatically handles proxy server and web server authentication. The mechanism handles web server realms and proxy server realms in proactive monitoring and management of web application environments distributed inside and outside of a corporate Intranet. By providing an authentication response, authentication may be done automatically without any user intervention by going through a list of available realms in realm list 322 or a realm that is available as part of the initial request that is associated to the transactions in the script, function, and/or procedure. Thus, the invention is an improvement over previous implementations, where monitoring software may stall every time one or more of the parameters in an authentication change.

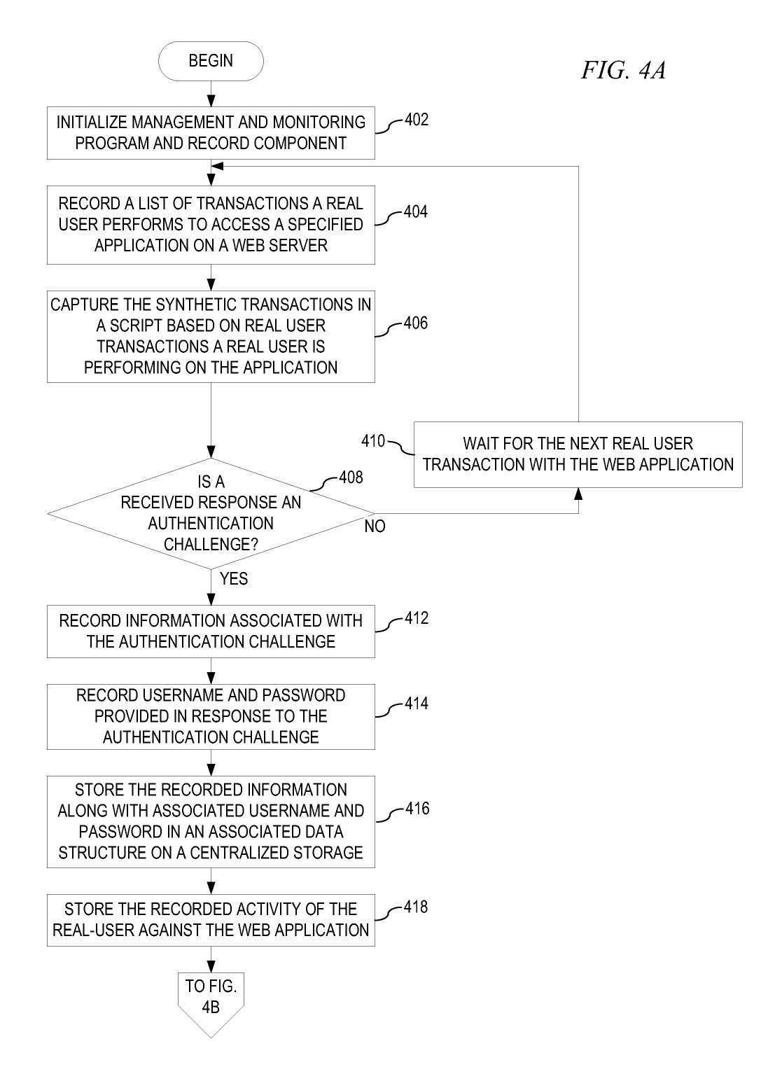

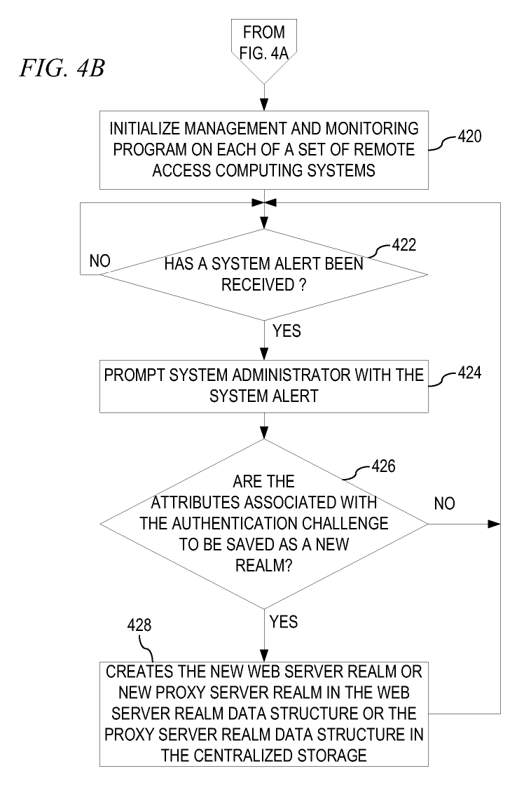

FIGS. 4A and 4B depict a flow chart for the operation performed by an administrator and recording endpoint of a management and monitoring system in accordance with an illustrative embodiment. As the operation begins, the administrator and recording endpoint initializes a management and monitoring program and record component (step 402). A monitoring agent within the management and monitoring program uses a recording component to record a list of transactions a real user performs to access a specified application on a web server (step 404). As the recording component captures the synthetic transactions in a script based on real user transactions a real user is performing on the application, the monitoring agent sends requests through a Web Browser or another application interface to each of the set of web servers (step 406). In response to each request for access from a real user, the recording component receives and records responses from the set of web servers or the set of proxy servers. For each response received and recorded, the recording component determines if the response is an authentication challenge from a web server or a proxy server (step 408). If at step 408 the response is not an authentication challenge, then the recording component waits for the next real user transaction with the web application (step 410) with the operation returning to step 404 thereafter.

If at step 408 the response is an authentication challenge, the recording component records information associated with the authentication challenge from the web server or proxy server, such as a type attribute, subnet, security realm name, or the like (step 412). The recording component may also record the username and password that is provided by the real-user in response to the authentication challenge that is used for successful authentication with the web server or proxy server (step 414). The recording component records this information for use in the synthetic transaction access to determine performance and availability. The recording component then stores the recorded web server information or proxy server information along with the associated recorded username and password as entries in a web server realm data structure or a proxy server realm data structure on a centralized storage (step 416). The management and monitoring program also stores the recorded activity of the real-user against the web application in the form of a script, function, and/or procedure on the centralized storage (step 418) for use in the synthetic transaction access to determine performance and availability of accessing the application on each of the web servers.

After the recording component populates the web server realm data structure and the proxy server realm data structure and the management and monitoring program populate the monitoring policy on the centralized storage, the administrator and recording endpoint initializes a management and monitoring program on each of a set of remote monitoring endpoints so that synthetic transactions may be sent to determine performance and availability of accessing the application on each of the web servers (step 420). After initializing the management and monitoring program on each of the set of remote monitoring endpoints, the management and monitoring program determines if a system alert is received from one of the set of remote monitoring endpoints (step 422). If at step 422 the administrator computer fails to receive a system alert, then the operation returns to step 422. If at step 422 the administrator computer system receives a system alert, the management and monitoring program on administrator and recording endpoint prompts the system administrator with the system alert (step 424). Then the management and monitoring program determines whether the administrator provides an indication to save the attributes associated with the authentication challenge as a new web server realm or a new proxy server realm (step 426). If at step 426 the administrator indicates that the information is to be saved as a new web server realm or a new proxy server realm, then the management and monitoring program stores the recorded web server information or proxy server information along with the associated recorded username and password as entries in the web server realm data structure or proxy server realm data structure on the centralized storage (step 428), with the operation returning to step 422 thereafter. If at step 426 the administrator fails to indicate that the information is to be saved, then the information is discarded and the operation returns to step 422.

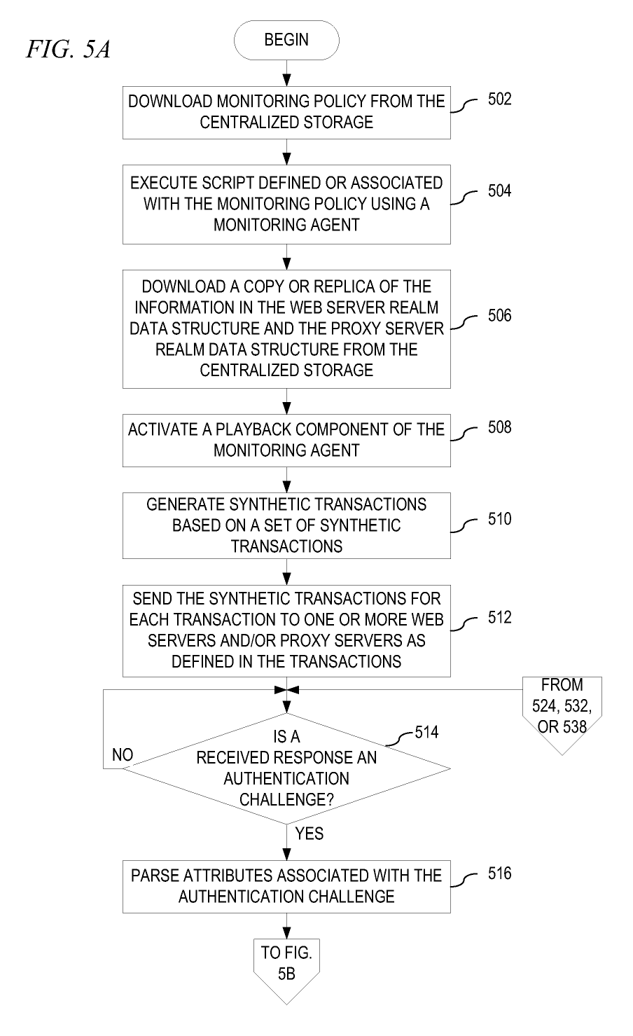

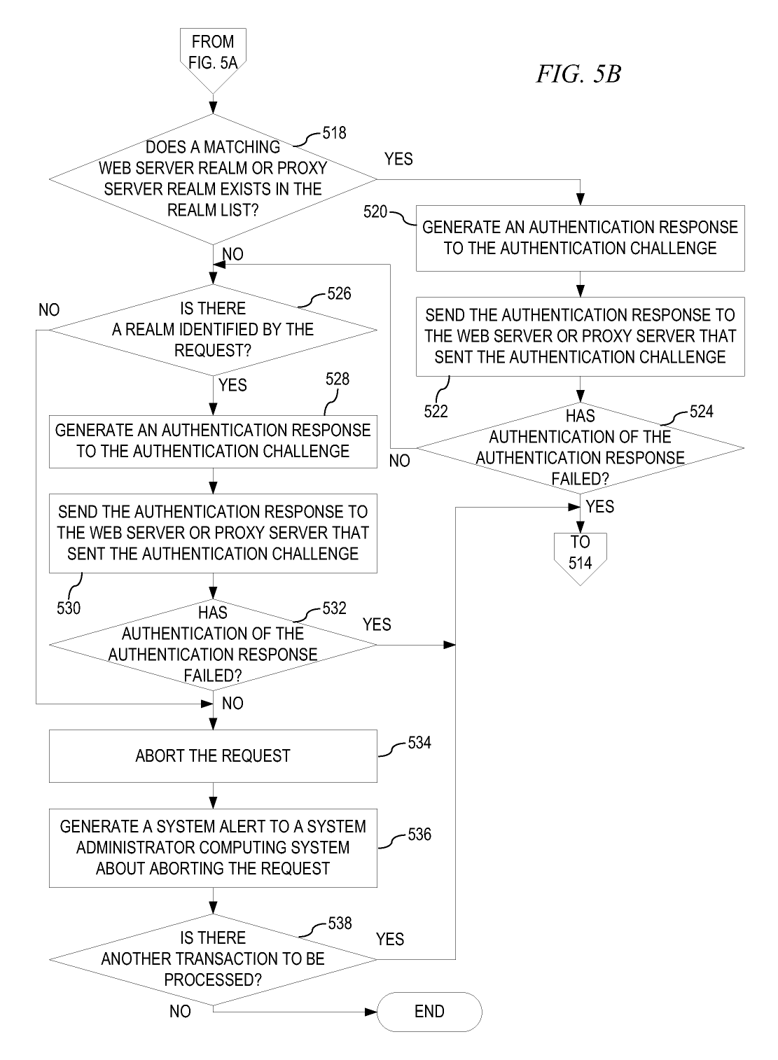

FIGS. 5A and 5B depict a flow chart for the operation performed by a remote monitoring endpoint of a management and monitoring system in accordance with an illustrative embodiment. As the operation begins, upon initialization by an administrator and recording endpoint, the remote monitoring endpoint downloads a monitoring policy from the centralized storage (step 502). The remote monitoring endpoint then executes a script defined or associated with the monitoring policy using a monitoring agent associated with the resident management and monitoring policy (step 504). The remote monitoring endpoint downloads a copy or replica of the information in the web server realm data structure and the proxy server realm data structure from the centralized storage, as a local realm list (step 506).

The remote monitoring endpoint then activates a playback component of the monitoring agent (step 508). The remote monitoring endpoint generates synthetic transactions based on the synthetic transactions in the script, function, or procedure (step 510) and sends the synthetic transactions for each transaction to one or more web servers and/or proxy servers as defined in the transactions depending on the path the request takes to the intended web server (step 512). In response to each request, the playback component may receive responses from the set of web servers or the set of proxy servers. For each response received, the playback component determines if the response is an authentication challenge from a web server or a proxy server (step 514). If at step 514 the response is not an authentication challenge, then the remote monitoring endpoint ignores the response and the operation returns to step 514.

If at step 514 the response is an authentication challenge from one of the set of web servers or the set of proxy servers, the playback component parses attributes associated with the authentication challenge, such as a type, subnet, realm name, or the like (step 516). The playback component then determines if a matching web server realm or proxy server realm exists in the realm list using the attributes of the authentication challenge and the attributes associated with the web server realms and proxy server realms in the realm list (step 518). If at step 518 the playback component identifies a web server realm or proxy server realm that matches the attributes parsed from the authentication challenge, then the playback component generates an authentication response to the authentication challenge associated with user transactions (step 520). The playback component formats the authentication response based on the authentication mechanism associated with the web server or proxy server that initiated the authentication challenge and identified by the playback component. The authentication response includes any information required by the identified authentication mechanism and the username and password associated with the identified web server realm or proxy server realm.

The playback component then sends the authentication response to the web server or proxy server that sent the authentication challenge (step 522). The playback component then determines if a failure of authentication is received from the web server or proxy server to which the authentication response was sent (step 524). If at step 524 the web server or proxy server that sent the authentication challenge accepts the authentication response, then the operation returns to step 514. If at step 518 the playback component fails to identify a web server realm or proxy server realm that matches the attributes parsed from the authentication challenge or if at step 524 the web server or proxy server that sent the authentication challenge fails to accept the authentication response, the playback component determines if another web server realm or proxy server realm may be identified (step 526).

That is, the playback component uses a web server realm or proxy server realm, if any, that is identified in the schedule, recorded script, function, procedure, or the like, for the transaction, situation, task, job, or the like, being performed by the initial request. If at step 526 the playback component identifies a web server realm or proxy server realm associated with the transaction, situation, task, job, or the like, the playback component generates an authentication response to the authentication challenge that is formatted based on the identified web server realm or proxy server realm associated with the initial request (strep 528). The playback component then sends the authentication response to the web server or proxy server that sent the authentication challenge (step 530). The playback component then determines if a failure of authentication is received from the web server or proxy server to which the authentication response was sent (step 532). If at step 532 the web server or proxy server that sent the authentication challenge accepts the authentication response, then the operation returns to step 514. If at step 526 the playback component fails to identifies a web server realm or proxy server realm associated with the transaction, situation, task, job, or the like or if at step 532 the web server or proxy server that sent the authentication challenge fails to accept the authentication response, then the monitoring agent aborts the request (step 534) and generates a system alert to the administrator and recording endpoint (step 536). The playback component then determines if there is another transaction in the script, function, or procedure that needs to be processed (step 538). If at step 538 there is another transaction in the script, function, or procedure that needs to be processed, then the operation returns to step 514 thereafter. If at step 538 there is not another transaction in the script, function, or procedure that needs to be processed, the operation terminates.

Thus, the illustrative embodiments provide mechanisms for automatically handling proxy server and web server authentication. The mechanisms handle web server realms and proxy server realms in proactive monitoring and management of web application environments distributed inside and outside of a corporate Intranet.

As noted above, it should be appreciated that the illustrative embodiments may take the form of an entirely hardware embodiment, an entirely software embodiment on a computer recordable medium, or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for automatically handling server authentication, the method comprising:
determining, by the data processing system, whether a response from a server to a synthetic transaction in a set of synthetic transactions contains an authentication challenge;
responsive to the response containing the authentication challenge, parsing, by the data processing system, the response to identify one or more attributes associated with the authentication challenge;
determining, by the data processing system, whether one or more attributes associated with each realm in a set of realms stored in a realm list matches the one or more attributes associated with the authentication challenge;
responsive to a match of the one or more attributes associated with a realm in the set of realms to the one or more attributes of the authentication challenge, generating, by the data processing system, an authentication response to the authentication challenge for the matched realm; and
sending, by the data processing system, the authentication response automatically to the server in order to authenticate the synthetic transaction.

2. The method of claim 1, wherein the server is at least one of a web server or a proxy server and wherein the realm is at least one of a web server realm or a proxy server realm.

3. The method of claim 1, further comprising:
responsive to a failure to determine a match of the one or more attributes associated with the realm in the set of realms to the one or more attributes of the authentication challenge, determining, by the data processing system, whether there is a realm identified for a transaction being performed by the synthetic transaction;
responsive to determining an existence of the realm for the transaction being performed by the synthetic request, generating, by the data processing system, the authentication response to the authentication challenge for the matched realm; and
sending, by the data processing system, the authentication response to the server in order to authenticate the synthetic transaction.

4. The method of claim 3, further comprising:
responsive to a failure in determining a realm identity within a set of known realms associated with the synthetic transaction, generating, by the data processing system, a system alert to a system administrator; and
aborting, by the data processing system, the synthetic transaction.

5. The method of claim 3, further comprising:
responsive to a failure in determining a realm identity within a set of known realms associated with the synthetic transaction, prompting, by the data processing system, to save the identified attributes as associated with a new realm; and
responsive to a positive indication that the identified attributes as associated with the new realm, generating, by the data processing system, the new realm in the realm list.

6. The method of claim 1, further comprising:
responsive to the response from the server to the synthetic transaction in the set of synthetic transactions containing an authentication challenge, recording, by a recording component, a set of attributes comprising at least one of a type, a subnet, a realm name, a username, or a password associated with the server; and
storing, by the recording component, the set of attributes in a centralized storage.

7. The method of claim 1, further comprising:
determining, by a recording component, whether a response from a server to a user transaction contains an authentication challenge;
responsive to the response containing the authentication challenge, parsing, by the recording component, the response to identify one or more attributes associated with the authentication challenge;
associating, by the recording component, the one or more attributes with a new realm in a set of realms in a realm list so that future detection of the one or more attributes can be matched with an authentication challenge in the new realm; and
storing, by the recording component, the set of attributes and realm list in a computer storage.

8. The method of claim 1, further comprising:
responsive to the response failing to contain an authentication challenge, proceeding, by the data processing system, to a next synthetic transaction in the set of synthetic transactions based on the a set of synthetic transactions.

9. The method of claim 1, wherein the one or more attributes associated with the authentication challenge are at least one of a type, a subnet, a realm name, a username, or a password.

10. A computer program product comprising a computer recordable medium having a computer readable program recorded thereon, wherein the computer readable program, when executed on a computing device, causes the computing device to:
determine whether a response from a server to a synthetic transaction in a set of synthetic transactions contains an authentication challenge;
responsive to the response containing the authentication challenge, parse the response to identify one or more attributes associated with the authentication challenge;
determine whether one or more attributes associated with each realm in a set of realms stored in a realm list matches the one or more attributes associated with the authentication challenge;
responsive to a match of the one or more attributes associated with a realm in the set of realms to the one or more attributes of the authentication challenge, generate an authentication response to the authentication challenge for the matched realm; and
send the authentication response automatically to the server in order to authenticate the synthetic transaction.

11. The computer program product of claim 10, wherein the server is at least one of a web server or a proxy server and wherein the realm is at least one of a web server realm or a proxy server realm.

12. The computer program product of claim 10, wherein the computer readable program further causes the computing device to:
responsive to a failure to determine a match of the one or more attributes associated with the realm in the set of realms to the one or more attributes of the authentication challenge, determine whether there is a realm identified for a transaction being performed by the synthetic transaction;
responsive to determining an existence of the realm for the transaction being performed by the synthetic request, generate the authentication response to the authentication challenge for the matched realm; and
send the authentication response to the server in order to authenticate the synthetic transaction.

13. The computer program product of claim 12, wherein the computer readable program further causes the computing device to:
responsive to a failure in determining a realm identity within a set of known realms associated with the synthetic transaction, generating a system alert to a system administrator; and
aborting the synthetic transaction.

14. The computer program product of claim 12, wherein the computer readable program further causes the computing device to:
responsive to a failure in determining a realm identity within a set of known realms associated with the synthetic transaction, prompt to save the identified attributes as associated with a new realm; and
responsive to a positive indication that the identified attributes associated with the new realm, generating the new realm in the realm list.

15. The computer program product of claim 10, wherein the computer readable program further causes the computing device to:
responsive to the response from the server to the synthetic transaction in the set of synthetic transactions containing an authentication challenge, record a set of attributes comprising at least one of a type, a subnet, a realm name, a username, or a password associated with the server; and
store the set of attributes in a centralized storage.

16. The computer program product of claim 10, wherein the computer readable program further causes the computing device to:
determine whether a response from a server to a user transaction contains an authentication challenge;
responsive to the response containing the authentication challenge, parse the response to identify one or more attributes associated with the authentication challenge;
associate the one or more attributes with a new realm in a set of realms in a realm list so that future detection of the one or more attributes can be matched with an authentication challenge in the new realm; and
store the set of attributes and realm list in a computer storage.

17. The computer program product of claim 10, wherein the one or more attributes associated with the authentication challenge are at least one of a type, a subnet, a realm name, a username, or a password.

18. The computer program product of claim 10, wherein the computer readable program is stored in a computer readable storage medium in a data processing system and wherein the computer readable program was downloaded over a network from a remote data processing system.

19. The computer program product of claim 10, wherein the computer readable program is stored in a computer readable storage medium in a server data processing system and wherein the computer readable program is downloaded over a network to a remote data processing system for use in a computer readable storage medium with the remote system.

20. An apparatus, comprising:
a processor; and
a memory coupled to the processor, wherein the memory comprises instructions which, when executed by the processor, cause the processor to:
determine whether a response from a server to a synthetic transaction in a set of synthetic transactions contains an authentication challenge;
responsive to the response containing the authentication challenge, parse the response to identify one or more attributes associated with the authentication challenge;
determine whether one or more attributes associated with each realm in a set of realms stored in a realm list matches the one or more attributes associated with the authentication challenge;
responsive to a match of the one or more attributes associated with a realm in the set of realms to the one or more attributes of the authentication challenge, generate an authentication response to the authentication challenge for the matched realm; and
send the authentication response automatically to the server in order to authenticate the synthetic transaction.
